(19) United States
(12) Patent Application Publication
(10) Pub. No.: US 2018/0096277 A1
(43) Pub. Date: Apr. 5, 2018

(54) METHOD FOR STANDARDIZED EVALUATION OF DRILLING UNIT PERFORMANCE

(71) Applicant: TDE Petroleum Data Solutions, Inc., Suger Land, TX (US)

(72) Inventors: Eric E. Maidla, Sugar Land, TX (US); Philipp Zoellner, Leoben (AT); Bouchra Lamik-Thonhauser, Leoben (AT)

(21) Appl. No.: 15/820,470

(22) Filed: Nov. 22, 2017

Related U.S. Application Data
(63) Continuation of application No. PCT/US2015/037570, filed on Jun. 25, 2015.

(51) Int. Cl. G06Q 10/06; E21B 41/00; E21B 47/00

(52) U.S. Cl. CPC G06Q 10/06393; E21B 19/16; E21B 47/00; E21B 41/0092

(57) ABSTRACT

A method for evaluating drilling unit performance includes automatically identifying at least one operating state of a drilling unit during operations thereof that is independent of conditions in a wellbore. Start times and stop times of the at least one operating state are determined. The automatically identifying and determining start and stop times are performed by comparing at least one drilling unit operating parameter measurement to a set of stored measurements corresponding to the operating state. An elapsed time of the at least one operating state is determined from the start times and the stop times. The elapsed time for the drilling unit is compared to a predetermined reference standard.

### CROSS-REFERENCE TO RELATED APPLICATIONS

Continuation of International Application No. PCT/US2015/037570 filed on Jun. 25, 2015 and incorporated herein by reference in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not Applicable

### BACKGROUND

This disclosure relates generally to the field of well drilling apparatus and methods for operating such apparatus. More specifically, the disclosure relates to a method for evaluating performance of one or more drilling units that is normalized with respect to performance measures within the control of the drilling unit operator. The disclosure further relates to methods for comparing such performance evaluation between different drilling units and/or between groups (“crew) of operating personnel on such drilling units.

Well drilling for creating wells in subsurface formations includes the use of a drilling unit or “rig” to lift, control and operate drilling tools for the purpose of drilling a well through such formations. Operating a drilling unit to drill a subsurface well includes a number of distinct functions each having a particular purpose. The distinct functions include those that are directly related to lengthening the well (drilling operations) and those that are ancillary to lengthening the well. Efficiency of a particular drilling unit and the personnel operating the particular drilling unit are known to be evaluated using time based measurements for each of the distinct functions.

U.S. Pat. No. 6,892,812 issued to Niedermayr et al. discloses a method for automatically determining which of the distinct functions is underway on a drilling unit at any moment in time. The automatic determination may be used in connection with a time recorder to measure the total time for each of the distinct functions in the drilling and completion of any particular well.

Some of the distinct functions may have operating time that is not totally within the control of the personnel operating the drilling unit. It is desirable, therefore, when using an automatic time based data recording system such as the one disclosed in the Niedermayr et al. '812 patent to evaluate the drilling unit and personnel performance in a way which normalizes the evaluation for such factors beyond the control of the drilling unit operating personnel.

### BRIEF DESCRIPTION OF THE DRAWINGS

FIG. 1 is a schematic diagram of a drilling unit that may be used in accordance with some embodiments.

FIG. 2 is a block diagram of an example monitoring system for automatically determining which of a plurality of distinct drilling unit functions is underway at any time.

FIG. 3 shows an example of classification of operating states and selected performance indicators associated with each classification of operating state.

FIG. 4 shows a system as explained with reference to FIG. 2 used on each of a plurality of drilling units for ranking each drilling unit's relative performance.

### DETAILED DESCRIPTION

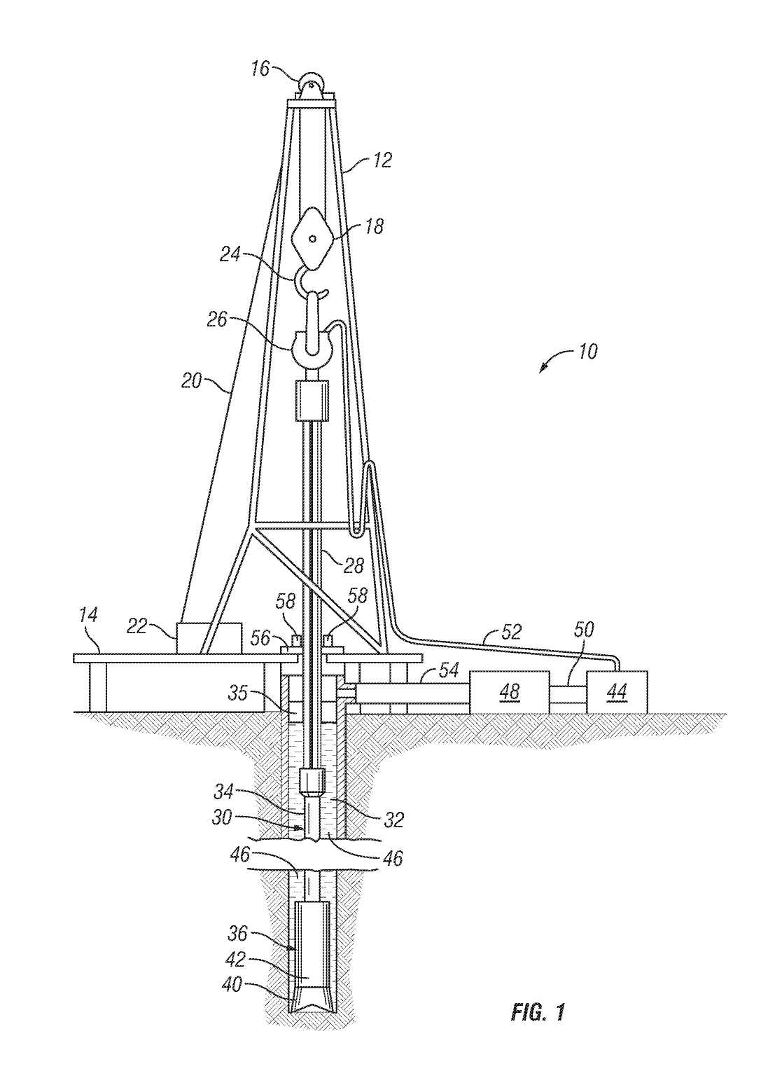

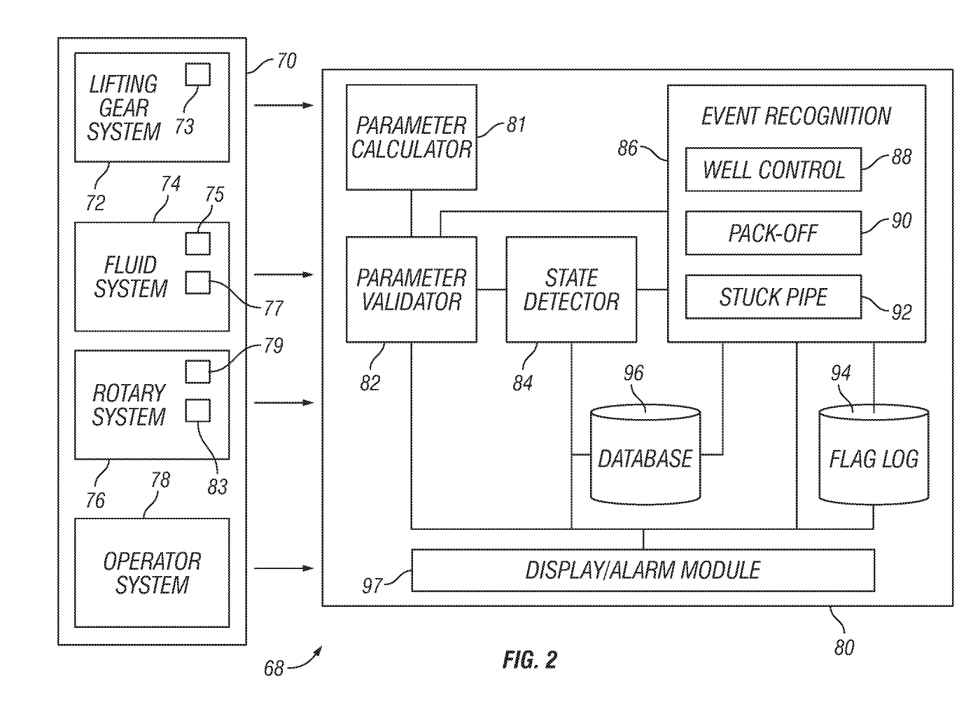

FIGS. 1 and 2 show an example drilling unit and a system for automatically determining which of a plurality of distinct drilling functions is underway at any time. A more detailed description of such a system is set forth in U.S. Pat. No. 6,892,812 issued to Niedermayr et al. As a matter of convenience, the distinct drilling functions will be referred to hereinafter as the “state” of operation of the drilling unit.

FIG. 1 illustrates an example embodiment of a drilling unit or “rig” 10. In this embodiment, the rig 10 is a conventional rotary land rig. However, methods according to the present disclosure are equally applicable to other suitable well drilling technologies and/or units, including top drive, power swivel, down hole motor, rotary steerable directional drilling devices, coiled tubing units, and the like, and to marine drilling rigs, such as jack up rigs, semisubmersibles, drill ships and any other form of mobile offshore drilling unit (MODU) that are operable to bore through subsurface geologic formations.

The rig 10 includes a mast 12 that is supported above a rig floor 14. A lifting gear includes a crown block 16 mounted to the mast 12 and a travelling block 18. The crown block 16 and the travelling block 18 are interconnected by a cable 20 that is driven by draw works 22 to control the upward and downward movement of the travelling block 18.

The travelling block 18 carries a hook 24 from which is suspended a swivel 26. The swivel 26 supports a kelly 28, which in turn supports a drill string, designated generally by the numeral 30 in the well bore 32. A blow out preventer (BOP) 35 is positioned at the top of the well bore 32. The drill string 30 may be held by slips 58 during connections and rig-idle situations or at other appropriate times.

The drill string 30 includes a plurality of interconnected sections of drill pipe or coiled tubing 34 and a bottom hole assembly (BHA) 36. The BHA 36 includes a rotary drilling bit 40 and a down hole, or mud, motor 42. The BHA 36 may also include stabilizers, drill collars, measurement well drilling (MWD) instruments, and the like.

Mud pumps 44 draw drilling fluid, or mud, 46 from mud tanks 48 through suction line 50. The drilling fluid 46 is delivered to the drill string 30 through a mud hose 52 connecting the mud pumps 44 to the swivel 26. From the swivel 26, the drilling fluid 46 travels through the drill string 30 to the BHA 36, where it turns the down hole motor 42 and exits the bit 40 to scour the formation and lift the resultant cuttings through the annulus to the surface. At the surface, the mud tanks 48 receive the drilling fluid from the well bore 32 through a flow line 54. The mud tanks 48 and/or flow line 54 include a shaker or other device to remove the cuttings.

The mud tanks 48 and mud pumps 44 may include trip tanks and pumps for maintaining drilling fluid levels in the well bore 32 during tripping out of hole operations and for receiving displaced drilling fluid from the well bore 32 during tripping-in-hole operations. In an example embodiment, the trip tank is connected between the well bore 32 and the shakers. A valve is operable to divert fluid away from the shakers and into the trip tank, which is equipped with a level sensor. Fluid from the trip tank can then be directly pumped back to the well bore via a dedicated centrifugal pump instead of through the standpipe.

Drilling is performed by applying weight to the bit 40 and rotating the drill string 30, which in turn rotates the bit 40. It will be appreciated by those skilled in the art that in some embodiments an hydraulic motor or other type of motor (not shown) may be connected within the drill string 30 and used to turn the bit 40. The drill string 30 is rotated within bore hole 32 by the action of a rotary table 56 rotatably supported on the rig floor 14. If used, the motor (not shown) may rotate the bit 40 independently of the drill string 30 and the rotary table 56. As previously described, the cuttings produced as bit 40 drills into the formations are carried out of bore hole 32 by the drilling fluid 46 supplied by pumps 44.

FIG. 2 illustrates an example well monitoring system 68 that may be used with methods in accordance with the present disclosure. In the present example embodiment, the monitoring system is a drilling monitoring system 68 for the rig 10. The monitoring system 68 comprises a sensing system 70 and a monitoring system 80 for drilling operations of the rig 10. Well monitoring systems for other well operations may comprise a sensing system with sensors similar, analogous or different to those of sensing system 70 for use in connection with a monitoring module, which may be similar, analogous or different than monitoring system 80. As described in more detail below, drilling operations may comprise drilling, tripping, testing, reaming, conditioning, and other and/or different operations, or states, of the drilling system. A state may be any suitable operation or activity or set of operations or activities of which all, some or most are based on a plurality of sensed parameters.

The sensing system 70 includes a plurality of sensors that monitor, sense, and/or report data, or parameters, on the rig 10, and/or in the bore hole 32. The reported data may comprise the sensed data or may be derived, calculated or inferred from sensed data.

In the illustrated embodiment, the sensing system 70 comprises a lifting gear system 72 that reports data sensed by and/or for the lifting gear; a fluid system 74 that reports data sensed by and/or for the drilling fluid tanks, pumps, and lines; rotary system 76 that reports data sensed by and/or for the rotary table or other rotary device; and an operator system 78 that reports data input by a driller/operator. As previously described, the sensed data may be refined, manipulated or otherwise processed before being reported to the monitoring module 80. It will be understood that sensors may be otherwise classified and/or grouped in the sensor system 70 and that data may be received from other additional or different systems, subsystems, and items of equipment. The systems that perform a well operation, which in some contexts may be referred to as subsystems, may each comprise related processes that together perform a distinguishable, independent, independently controllable and/or separable function of the well operation and that may interact with other systems in performing their function of the operation.

The lifting gear system 72 includes a hook weight sensor 73, which may comprise digital strain gauges or other sensors that report a digital weight value once a second, or at another suitable sensor sampling rate. The hook weight sensor may be mounted to the static line (not shown) of the cable 20.

The fluid system 74 includes a stand pipe pressure sensor 75 which reports a digital value at a sampling rate of the pressure in the stand pipe. The drilling fluid system may also include a mud pump sensor 77 that measures mud pump speed in strokes per minute, from which the flow rate of drilling fluids into the drill string can be calculated. Additional and/or alternative sensors may be included in the drilling fluid system 74 including, for example, sensors for measuring the volume of fluid in mud tank 46 and the rate of flow into and out of mud tank 46. Also, sensors may be included for measuring mud gas, flow line temperature, and mud density.

The rotary system 76 includes a rotary table revolutions per minute (RPM) sensor 79 which reports a digital value at a sampling rate. The RPM sensor may also report the direction of rotation. A rotary torque sensor 83 may also be included which measures the amount of torque applied to drill string 30 during rotation. The torque may be indicated by measuring the amount of current drawn by the motor that draws rotary table 46. The rotary torque sensor may alternatively sense the tension in the rotary table drive chain.

The operating system 78 comprises a user interface or other input device that receives input from a human operator/driller who may monitor and report observations made during the course of drilling. For example, bit position (BPOS) may be reported based upon the length of the drill string 30 that has gone down hole, which in turn is based upon the number of drill string segments the driller has added to the string during the course of drilling. The driller/operator may keep a tally book of the number of segments added, and/or may input this information in a supervisory control and data acquisition (SCADA) reporting system.

Other parameters may be reported or calculated from reported values. For example, other suitable hydraulic and/or mechanical data may be reported. Hydraulic data is data related to the flow, volume, movement, rheology, and other aspects of drilling or other fluid performing work or otherwise used in operations. The fluids may be liquid, gaseous or otherwise. Mechanical data is data related to support or physical action upon or of the drill string, bit or any other suitable device associated with the drilling or other operation. Mechanical and hydraulic data may originate with any suitable device operable to accept, report, determine, estimate a value, status, position, movement, or other parameter associated with a well operation. As previously described, mechanical and hydraulic data may originate from machinery sensor data such as motor states and RPMs and for electric data such as electric power consumption of top drive, mud transfer pumps or other satellite equipment. For example, mechanical and/or hydraulic data may originate from dedicated engine sensors, centrifugal on/off sensors, valve position switches, fingerboard open/close indicators, SCR readings, video recognition and any other suitable sensor operable to indicate and/or report information about a device or operation of a system. In addition, sensors for measuring well bore trajectory, and/or petrophysical properties of the geologic formations, as well down hole operating parameters, may be sensed and reported. Down hole sensors may communicate data by wireline, mud pulses, acoustic wave, and the like. Thus, the data may be received from a large number of sources and types of instruments, instrument packages and manufacturers and may be in many different formats. The data may be used as initially reported or may be reformatted and/or converted. In a particular embodiment, data may be received from two, three, five, ten, twenty, fifty, a hundred or more sensors and from two, three, five, ten or more systems. That data and/or information determined from the data may be a value or other indication of the rate, level, rate of change, acceleration, position, change in position, chemical makeup, or other measurable information of any variable of a well operation.

The monitoring system 80 receives and processes data from the sensing system 70 or from other suitable sources and monitors the drilling system and conditions based on the received data. As previously described, the data may be from any suitable source, or combinations of sources and may be received in any suitable format. In one embodiment, the monitoring system 80 comprises a parameter calculator 81, a parameter validator 82, an operating state determination detector 84, an event recognition module 86, a database 96, a flag log 94, and a display/alarm module 97. It will be understood that the monitoring system 80 may include other or different programs, modules, functions, database tables and entries, data, routines, data storage, and other suitable elements, and that the various components may be otherwise integrated or distributed between physically disparate components. In a particular embodiment, the monitoring module 80 and its various components and modules may comprise logic encoded in media. The logic may comprise software stored on a computer-readable medium for use in connection with a general purpose processor, or programmed hardware such as application-specific integrated circuits (ASIC), field programmable gate arrays (FPGA), digital signal processors (DSP) and the like.

The parameter calculator 81 derives/infers or otherwise calculates state indicators for drilling operations based on reported data for use by the remainder of monitoring system 80. Alternatively, the calculations could be conducted by processes or units within the sensing systems themselves, by an intermediary system, the operating state detector 84, or by the individual module of the monitoring system 80. A state indicator is a value or other parameter based on sensed data and is indicative of the state of drilling operations. In one embodiment, the state indicators comprise measured depth (MD), hook load (HKLD), bit position (BPOS), stand pipe pressure (SPP), and rotary table revolutions per minute (RPM).

The state indicators, either directly reported or calculated via calculator 81 and other parameters, may be received by the parameter validator 82. The parameter validator 82 recognizes and eliminates corrupted data and flags malfunctioning sensor devices. In one embodiment, the parameter validation compares each parameter to a status and/or dynamic allowable range for the parameter. The parameter is flagged as invalid if outside the acceptable range. As used herein, each means every one of at least a subset of the identified items. Reports of corrupted data or malfunctioning sensor devices can be sent to and stored in flag log 94 for analysis, debugging, and record keeping.

The validator 82 may also smooth or statistically filter incoming data. Validated and filtered parameters may be directly utilized for event recognition, or may be utilized to determine the state drilling operations of the rig 10 via the operating state determination detector 84.

The operating state determination detector 84 uses combinations of state indicators to determine the current state of drilling operations. The state may be determined continuously at a suitable update rate and in real time. A operating state is an overall conclusion regarding the status of the well operation at a given point in time based on the operation of and/or parameters associated with one or more key drilling elements of the rig. Such elements may include the bit, string, and drilling fluid.

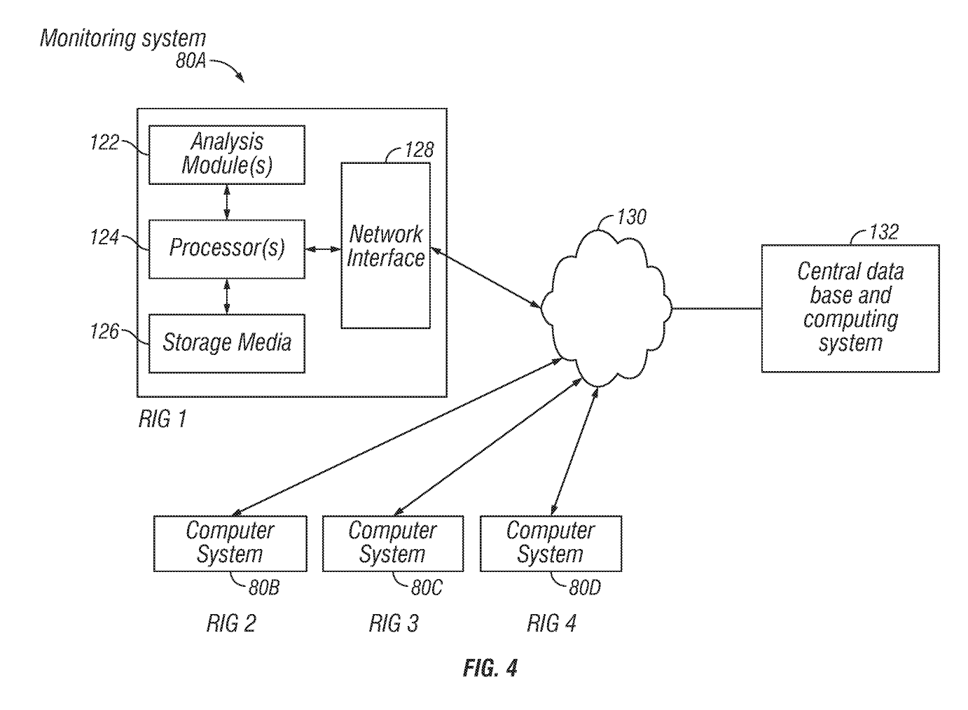

In one embodiment, the state determination detector 84 stores a plurality of possible and/or predefined states for drilling operations for the rig 10. The states may be stored by storing a listing of the states, storing logic differentiating the states, storing logic operable to determine disparate states, predefining disparate states or by otherwise suitably maintaining, providing or otherwise storing information from which disparate states of an operation can be determined. In this embodiment, the state of drilling operations may be selected from the defined set of states based on the state indicators. For example, if the bit is substantially off bottom, there is no substantial rotation of the string, and drilling fluid is substantially circulating, then based on this set of state indicators, operating state detector 84 determines the state of drilling operations to be and/or described as circulating off bottom. On the other hand, if the drill bit is moving into the hole and the string is rotating, but there is no circulation of drilling fluid, the state of drilling operations can be determined to be and/or described as working pipe. Examples and explanations of these and other operating states and their determination by the operating state determination detector 84 may be found in reference to FIGS. 4 and 5 in the Niedermayr et al. patent referred to above. The states may be stored locally and/or remotely, may be titled or untitled, may be represented by any suitable type of signal and may be determined mathematically, by comparisons, by logic trees, by lookups, by expert systems such as an inference engine and in any other suitable manner. The states may be sections or parts of a continuous spectrum. Thus, for example, the state may be determined by selection of a predefined state based on matching criteria and/or one or more comparisons. The state may be determined repetitively, continuously, substantially continuously or otherwise. A process is substantially continuous when it is continuous for a majority of processes for a well operation and/or cycles on a periodic basis on the order of magnitude of a second, or less.

The event recognition module 86 receives drilling parameters and/or operating state conclusions and recognizes or flags events, or conditions. Such conditions may be alert conditions such as hazardous, troublesome, problematic or noteworthy conditions that affect the safety, efficiency, timing, cost or other aspect of a well operation. For drilling operations, drilling events comprise potentially significant, hazardous, or dangerous happenings or other situations encountered while drilling that may be important to flag or bring to the attention of a drilling supervisor. Events may include stuck pipe, pack off, or well control events such as kicks.

The event recognition module 86 may comprise sub-modules operable to recognize different kinds of events. For example, well control events such as kick-outs may be recognized via operation of well control sub-module 88. A well control event is any suitable event associated with a well that can be controlled by application or adjustment of a well fluid, flow, volume, or device such as circulation of fluid during drilling operations. Pack-off events, such as, for example, when drill cuttings clog the annulus, may be recognized via operation of pack-off sub-module 90, and stuck pipe events may be recognized via operation of stuck pipe sub-module 92. Other events may be useful to recognize and flag, and the event recognition module 86 may be configured with other modules with which this is accomplished. Control evaluation and/or decisions may be performed continuously, repetitively and/or substantially continuously as previously described. In another embodiment, the state and event recognition may be performed in response to one or more predefined events or flags that arise during the well operation.

Drilling parameters, operating states, event recognitions, and alert flags may be displayed to the user on display/alarm module 97, stored in database 96, and/or made accessible to other modules within monitoring system 80 or to other systems or users as appropriate. Database 96 may be configured to record trends in data over time. From these data trends it may be possible, for example, to infer and flag long-term effects such as bore-hole degradation caused by repeated tripping within the bore hole.

In operation, the monitoring system 80 may allow for an increase in quality control with respect to sensing devices and the monitoring of the timing and efficiency of drilling operations. Events such as kicks (fluid influx) may be accurately detected and flagged while drilling earlier than is possible via human observation of rig operations, thus resulting in the more effective taking of corrective operations and a reduction in the frequency and severity of undesirable events. In addition, the provisioning of state information may allow false alarms to be minimized, more accurate event recognition and residual down time. Another potential benefit may be an increased ability to automate daily and end-of-well reporting procedures.

The operating states may be determined, control evaluation provided, and/or events recognized without manual or other input from an operator or without direct operator input. Operator input may be direct when the input forms a state indicator used directly by the state engine. In addition, the state, evaluation and recognition processes may be performed without substantial operator input. For example, processes may run independently of operator input but may utilize operator overrides of erroneous readings or other analogous inputs during instrument or other failure conditions. It will be understood that a process may run independently of operator input during operation and/or normal operation and still be manually, directly, or indirectly started, initiated, interrupted or stopped. With or without operator input, the state recognition processes are substantially based on instrument sensed parameters that are monitored in real-time and dynamically changing.

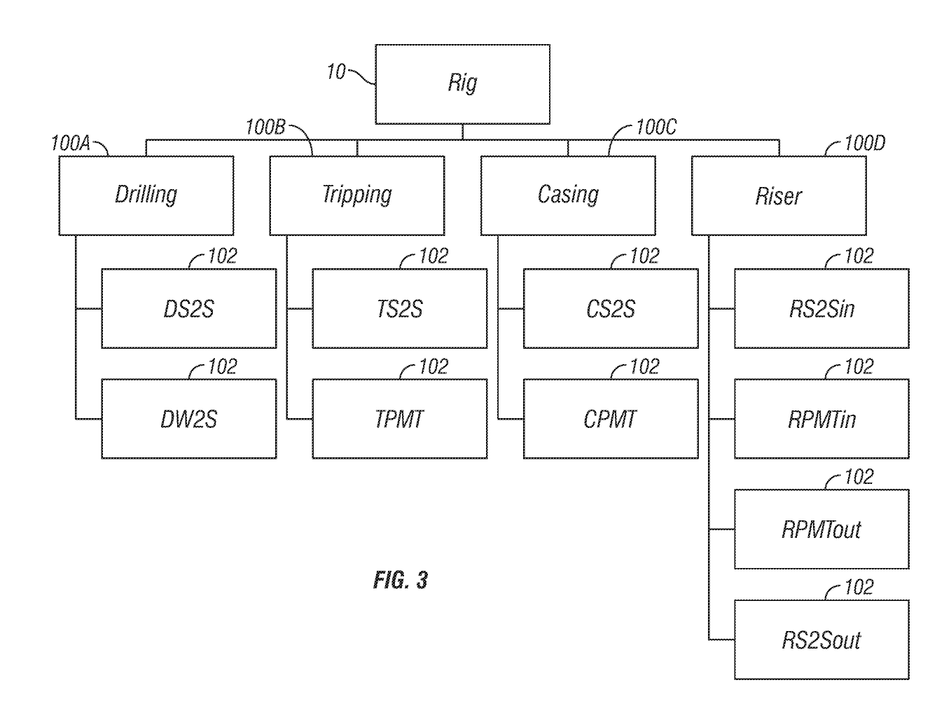

Having explained how operating states may be determined, methods according to the present disclosure for calculating normalized drilling unit performance measures will be explained. Referring to FIG. 3, for any drilling unit, classifications of operating states may be made with reference to the type of pipe being moved by the rig 10 or a broad class of operations. For example, any operation related to lengthening the well may be classified as a Drilling state, at 100A. In any state classified as Drilling, the drill string (30 in FIG. 1) will be in the wellbore. Any state related to Tripping, at 100B, will include actions performed on the drill string (30 in FIG. 1) to partially or completely remove the drill string from the wellbore, or conversely, to partially or completely insert the drill string into the wellbore.

After drilling of a selected length of wellbore, or when the wellbore is drilled to its intended final depth, a pipe or casing may be inserted into the wellbore and cemented in place therein. At 100C, any state related to insertion of the casing into the wellbore and cementing thereafter may be classified as Casing.

For marine drilling operations where a well pressure control device (wellhead) is disposed on the bottom of a body of water and a conduit, called a riser, extends from the wellhead to the rig at the water surface, any operating state related to the assembly or disassembly of the riser may be classified, at 100D as Riser.

Each of the classifications of operating states set forth above, e.g., Drilling, Tripping, Casing, and Riser will have associated therewith certain performance indicators, each shown at 102. By way of example the following definitions may be used for certain selected performance indicators (PIs) associated with each of the above described classified states:

DS2S: Drilling-Slip to Slip is the elapsed time required to add one section (“making a connection”) of pipe or a drilling tool to the drill string during drilling operations. The time measurement begins when drilling stops and the drill string is suspended in the slips. The time measurement ends when the drill string is lifted from the slips to resume drilling after the section of pipe or drilling tool is added to the drill string. Conversely, time may be measured “slip to slip” when a section of pipe or drilling tool is removed from the drill string (“breaking a connection”).

DW2S: Drilling-Weight to Slip is the elapsed time from the moment drilling is interrupted for making a connection to the time the drill string is set in the slips.

TS2S: Tripping-Slip to Slip is the pipe or tool connection time during tripping operations. It is similar to DS2S but is measured during the class of operating states related to tripping as explained above.

TPMT: Tripping Pipe Moving Time is the elapsed time that it takes to move the drill string between two drill string connection points during tripping operations.

CS2S: Casing Slip to Slip is the elapsed time as in DS2S but for inserting casing into a wellbore.

CPMT: Casing Pipe Moving Time is the elapsed time similar to TPMT but is associated with inserting casing into a wellbore.

RS2Sin: is the elapsed time for assembling riser (moving the riser into a body of water) Slip to Slip.

RS2Sout: is the elapsed time for disassembling riser (moving the riser out of a body of water) Slip to Slip.

RPMTin: Riser Pipe Moving Time is the elapsed time between two riser connection points while moving the riser into a body of water.

RPMTout: Riser Pipe Moving Time is the elapsed time between two riser connection points while moving the riser out of the body of water.

The elapsed time may be measured for each PI by using the state detector (84 in FIG. 2) to automatically determine the start time and stop time of each of the above described PI operating states. The corresponding elapsed time may be calculated from the start and stop times.

In some embodiments, the elapsed time for one or more PI operating states may be compared to a predetermined reference standard. In some embodiments, the predetermined reference standard may be a theoretical minimum elapsed time calculated using the physical capacities of the particular drilling rig such as a maximum speed at which the draw works (22 in FIG. 1) is capable of moving the traveling block (18 in FIG. 1) and a maximum rotational speed of the rotary table or top drive. The maximum speed of any of the physical capacities of the particular drilling rig may be normalized for the length of the pipe being acted upon. In some embodiments, similar drilling rigs, i.e., those having similar draw works, rotary tables or top drives, etc. may have their elapsed times for corresponding PI operating states used to calculate an average value of elapsed time for any one or more PI operating states. In such case, the average value may be used as the reference standard.

In some embodiments, the reference standard may be a value of elapsed time for a corresponding PI operating state on one or more additional drilling rigs. In some embodiments, values of each PI on each of a plurality of drilling rigs having equipment substantially as explained with reference to FIGS. 1 and 2 may be used to determine a relative performance indicator called a “Ranking Factor” (RF) for each PI operating state for each drilling rig, as well as calculating an overall Ranking Factor for each drilling rig. Further, each Ranking Factor, both for individual PI operating states and for each drilling rig overall, may be associated with a particular rig using entity, e.g., an oil and gas producing company, or associated with a particular drilling rig contracting entity.

The foregoing PI operating states are only provided as examples of PI operating states that may be used in accordance with methods according to the present disclosure; those skilled in the art will readily determine other relevant operating states that may be used in accordance with the present disclosure. For purposes of defining the scope of the present disclosure, the relevant operating states for which elapsed times are measured and for which PIs are calculated are those which are entirely within the control of the drilling rig and its operating personnel. Expressed differently, the operating states which may be affected by the subsurface formations or the condition of the well may be excluded from use in evaluating performance of the drilling rig and/or personnel.

In methods according to the present disclosure, the selected performance indicators (PIs) may be used as follows.

First, a selection may be made of the set of data that are intended to be analyzed. The selection of data may be made with respect to a geologic basin or other defined geographical area, with respect to the rig class (deeper or shallower capacity rigs), or any other predetermined criterion.

Next, an average elapsed time value for a particular Performance Indicator (PI) may be made using all the universe of data selected. The average may be referred to as a “Target PI” (tPI) for each PI. The Target PI may be represented by the term tPI.

Ranking Factors (RF) for each PI may then be calculated as follows.

nPIa=the number of PIa data points considered for a particular drilling rig.

PIa=are the particular individual data values of the selected PI of a particular rig.

$$RFPIa = \frac{( tPIa ) \times ( nPIa )}{Σ PIa} \qquad ( 1 )$$

Each PI may be represented by an associated subscript a, b, c, . . . .

Next, target values for all PIs within a selected class of operating states may be calculated as follows.

$${RFOP}_{1} = \frac{( tPIa \times nPIa ) + ( tPIb \times nPIb )}{( Σ PIa + Σ PIb )} \qquad ( 2 )$$

wherein each PI is represented by a corresponding subscript, a, b, c, . . . and each class of states is represented by a corresponding subscript, 1, 2, 3, . . . .

The foregoing ranking factor calculation may be repeated for all classes of operations on any particular drilling rig. Then, the same ranking factor calculations may be repeated for one or more additional rigs as follows.

$${RFRig}_{1} = \frac{\begin{matrix}( tPIa \times nPIa ) + ( tPIb \times nPIb ) + \\ ( tPIc \times nPIc ) + ( tPId \times nPId ) + …\end{matrix}}{Σ PIa + Σ PIb + Σ PIc + Σ PId + …} \qquad ( 3 )$$

wherein each PI is represented by a respective subscript a, b, c, . . . and each rig is represented by a respective subscript 1, 2, 3, . . . .

Any of the foregoing measurements and calculations may be repeated for any one or more drilling rigs at selected times, and changes in the ranking factor for any one or more PIs may be recorded.

It will also be appreciated that when the foregoing measurements and calculations are performed for any individual drilling rig, it is possible to evaluate and/or rank the performance of personnel operating the drilling rig at any time. For example, in typical drilling operations, two separate “crews” of personnel operate the drilling unit for 12 hours each in 24 hour daily operations. Each of the two crews may have its performance evaluated against the other using the measurements and calculations explained above with reference to FIG. 3. It is also possible to compare crews between different drilling units using the same measurements and calculations.

In using a performance evaluation method according to the present disclosure for multiple rigs, it is contemplated that each rig will include an operating state detection and time recording system as explained with reference to FIG. 2. Referring to FIG. 4, an example multiple rig implementation may include an operating state detection and time recording system as described with reference to FIG. 2 on each of a plurality of drilling rigs. Each of the foregoing operating state detection and time recording systems, shown at 80A, 80B, 80C and 80D may include one or more analysis modules 122 that may be configured to perform various tasks according to some embodiments, such as the tasks explained with reference to FIG. 2 and FIG. 3. To perform these various tasks, the analysis module 122 may operate independently or in coordination with one or more processors 124, which may be connected to one or more storage media 126. A display device (not shown) such as a graphic user interface of any known type may be in signal communication with the processor 124 to enable user entry of commands and/or data and to display results of execution of a set of instructions according to the present disclosure.

The processor(s) 124 may also be connected to a network interface 128 to allow each individual system 80A, 80B, 80C, 80D to communicate over a data network 130 with one or more additional individual computer systems and/or computing systems. In the present example embodiment, the data network 130 may be in communication with a central data base and computing system 132, wherein the various ranking factors described above may be calculated, stored and displayed.

A processor may include, without limitation, a microprocessor, microcontroller, processor module or subsystem, programmable integrated circuit, programmable gate array, or another control or computing device.

The storage media 126 may be implemented as one or more computer-readable or machine-readable storage media. Note that while in the example embodiment of FIG. the storage media 126 are shown as being disposed within the individual computer system 80A, in some embodiments, the storage media 126 may be distributed within and/or across multiple internal and/or external enclosures of the individual computing system 80A. Storage media 126 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that the individual systems 80A-80D and 132 are only one example of a computing system, and that any other embodiment of a computing system may have more or fewer components than shown, may combine additional components not shown in the example embodiment of FIG. 4. The various components shown in FIG. 4 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

As previously explained, the foregoing ranking procedure may be extended to an entity, such as a hydrocarbon producing company that uses several different drilling rig contracting companies. Thus, the producing company will have a tool to evaluate the performance of each drilling rig and each contractor.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for evaluating drilling unit performance, comprising:
automatically identifying at least one operating state of a drilling unit during operations thereof that is substantially independent of conditions in a wellbore;
automatically determining start times and stop times of the at least one operating state, wherein the automatically identifying and determining start and stop times are performed by comparing at least one drilling unit operating parameter measurement to a set of stored measurements corresponding to the operating state;
automatically determining an elapsed time of the at least one operating state from the start times and the stop times;
automatically comparing the elapsed time for the drilling unit to a predetermined reference standard; and
using the compared elapsed time to adjust operating procedures of at least one crew on the drilling unit when the elapsed time exceeds the predetermined reference standard.

2. The method of claim 1 wherein the predetermined reference standard comprises a corresponding elapsed time for at least one operating state on at least one other drilling unit.

3. The method of claim 1 wherein the elapsed time comprises a time elapsed making or breaking a connection during tripping operations.

4. The method of claim 1 wherein the elapsed time comprises a time elapsed making or breaking a connection during drilling operations.

5. The method of claim 1 wherein the elapsed time comprises a time elapsed moving a drill string between drilling the wellbore and setting the drill string in slips.

6. The method of claim 1 wherein the elapsed time comprises a time elapsed moving a drill string between two connection points during tripping.

7. The method of claim 1 wherein the elapsed time comprises a time elapsed making a connection during casing operations.

8. The method of claim 1 wherein the elapsed time comprises a time elapsed moving a casing into a wellbore between two casing connection points during casing operations.

9. The method of claim 1 wherein the elapsed time comprises a time elapsed moving a riser into a body of water between two riser connection points during riser operations.

10. The method of claim 1 wherein the elapsed time comprises a time elapsed moving a riser out of a body of water between two riser connection points during riser operations.

11. The method of claim 1 wherein the elapsed time comprises a time elapsed making or breaking a riser connection.

12. The method of claim 1 further comprising determining elapsed times for the at least one operating state for at least two drilling units and calculating a target performance indicator therefrom; and using the target performance indicator to adjust operating procedures of at least one drilling crew on at least one of the at least two drilling units.

13. The method of claim 12 further comprising determining a ranking factor for at least one drilling unit based on the target performance indicator; and using the ranking factor to adjust operating procedures on a first drilling unit having a lower ranking factor than at least a second drilling unit.

14. The method of claim 13 further comprising determining at least one ranking factor for a plurality of drilling units and ranking each drilling unit according to its ranking factor.

15. The method of claim 1 further comprising determining elapsed times for a plurality of operating states for each drilling unit, each operating state substantially independent of conditions in a wellbore, and calculating a target performance indicator for each of the operating states; and
using the compared elapsed time to adjust operating procedures of at least one crew on the drilling unit.

16. The method of claim 15 further comprising determining a ranking factor for each drilling unit for each target performance indicator based on the elapsed times for each operating state for each drilling unit.

17. The method of claim 16 further comprising determining an overall ranking factor for each drilling unit based on an average of all ranking factors for each drilling unit for all target performance indicators.

18. The method of claim 17 further comprising ranking each drilling unit by comparing the ranking factor thereof to the ranking factors determined for the other drilling units.

19. The method of claim 1 further comprising repeating the determining start and stop times, determining elapsed time and comparing the elapsed time to a reference standard at selected times.

20. The method of claim 19 further comprising repeating determining elapsed times for the at least one operating state for at least two drilling units and repeating calculating a target performance indicator therefrom at selected times.

21. The method of claim 20 further comprising determining a ranking factor for at least one drilling unit based on the target performance indicator at selected times.

22. The method of claim 21 further comprising determining at least one ranking factor for a plurality of drilling units and ranking each drilling unit according to its ranking factor at selected times.
